(19) United States
(12) Patent Application Publication
(10) Pub. No.: US 2026/0141919 A1
(43) Pub. Date: May 21, 2026

(54) MAGNETIC DISK DEVICE

(71) Applicants: Kabushiki Kaisha Toshiba, Kawasaki (JP); Toshiba Electronic Devices & Storage Corporation, Kawasaki (JP)

(72) Inventors: Takuya MORI, Yokohama Kanagawa (JP); Tetsuo KURIBAYASHI, Yokohama Kanagawa (JP); Takao AOKI, Kawasaki Kanagawa (JP); Takahiro KAWAI, Yokohama Kanagawa (JP)

(21) Appl. No.: 19/308,089

(22) Filed: Aug. 22, 2025

(30) Foreign Application Priority Data
Sep. 20, 2024 (JP) 2024-163970

(51) Int. Cl. G11B 5/09; G11B 5/55

(52) U.S. Cl. CPC G11B 5/09; G11B 5/5547

(57) ABSTRACT

A refresh operation is executed in response to a first trigger or a second trigger. The refresh operation includes a seek operation, a stabilization operation to wait for attenuation of residual vibration of a magnetic head, and a rewrite operation to rewrite all data of a first storage area to the first storage area after the stabilization operation. The controller decreases a value of a counter corresponding to the first storage area in response to the rewrite operation. The controller increases a value of a counter corresponding to a second storage area in response to the rewrite operation. The stabilization operation includes an operation to determine whether a completion condition is satisfied. The completion condition varies depending on a trigger for executing the refresh operation.

### CROSS-REFERENCE TO RELATED APPLICATION(S)

This application is based upon and claims the benefit of priority from Japanese Patent Application No. 2024-163970, filed Sep. 20, 2024, the entire contents of which are incorporated herein by reference.

### FIELD

Embodiments described herein relate generally to a magnetic disk device.

### BACKGROUND

During writing to a target track on a magnetic disk, adjacent tracks are subject to an influence known as adjacent track interference (ATI). As the number of times of writing to a single track increases, the ATI on adjacent tracks accumulates, and data written on the adjacent tracks eventually become difficult to read. Therefore, a rewrite of all data written on the adjacent tracks is executed on the adjacent tracks before the data of the adjacent tracks become too difficult to read. This rewrite is also called refresh.

### BRIEF DESCRIPTION OF THE DRAWINGS

FIG. 1 is a schematic diagram illustrating an example of a configuration of a magnetic disk device according to an embodiment.

FIG. 2 is a diagram illustrating an example of a configuration of a magnetic disk according to an embodiment.

FIG. 3 is a diagram illustrating a stabilization operation according to an embodiment.

FIG. 4 is a graph showing an increment amount of an ATI counter according to an embodiment.

FIG. 5 is a diagram illustrating an example of management information stored in a RAM according to an embodiment.

FIG. 6 is a table showing an example of a configuration of quality control information according to an embodiment.

FIG. 7 is a graph showing an ATI counter update ratio according to an embodiment.

FIG. 8 is a table showing an example of a configuration of parameter setting information according to an embodiment.

FIG. 9 is a graph showing an example of a relationship between a stabilization time threshold value and an adjusted refresh efficiency in a forced refresh operation according to an embodiment.

FIG. 10 is a graph showing an example of a relationship between a stabilization time threshold value and an adjusted refresh efficiency in an idle refresh operation according to an embodiment.

FIG. 11 is a flowchart showing an example of a series of operations related to a write operation according to an embodiment.

FIG. 12 is a flowchart showing an example of a trigger for execution of a forced refresh operation according to an embodiment.

FIG. 13 is a flowchart showing an example of a trigger for execution of an idle refresh operation according to an embodiment.

FIG. 14 is a flowchart showing an example of a series of operations related to a refresh operation according to an embodiment.

FIG. 15 is a flowchart showing an example of a write quality control operation according to an embodiment.

FIG. 16 is a table showing an example of calculations in a write quality control operation according to an embodiment.

### DETAILED DESCRIPTION

Embodiments provide a magnetic disk device that can suitably execute a rewrite operation caused by adjacent track interference (ATI).

In general, according to one embodiment, a magnetic disk device includes a magnetic disk, a magnetic head, a memory, and a controller. The magnetic disk includes a plurality of storage areas arranged in a radial direction. In the memory, a plurality of counters, each of which corresponds to one of the plurality of storage areas, are stored. The controller executes a write operation in response to a write command. When executing the write operation, the controller increases a value of a counter corresponding to a storage area in the vicinity of a target storage area to which data is written in the write operation. The controller executes a refresh operation in response to each of a first trigger and a second trigger different from the first trigger. The refresh operation includes a seek operation to move the magnetic head to a first storage area among the plurality of storage areas, a stabilization operation to wait for attenuation of residual vibration of the magnetic head after the seek operation is completed, and a rewrite operation to rewrite all data of the first storage area to the first storage area after the stabilization operation. The controller decreases a value of a counter corresponding to the first storage area in response to the rewrite operation. The controller increases a value of a counter corresponding to a second storage area in response to the rewrite operation. The second storage area is a storage area in the vicinity of the first storage area among the plurality of storage areas. The stabilization operation includes an operation to determine whether a completion condition is satisfied. The completion condition is a first condition when the refresh operation is executed in response to the first trigger and a second condition different from the first condition when the refresh operation is executed in response to the second trigger.

Hereinafter, a magnetic disk device according to embodiments will be described in detail with reference to the accompanying drawings. The present disclosure is not limited to these embodiments.

### Embodiments

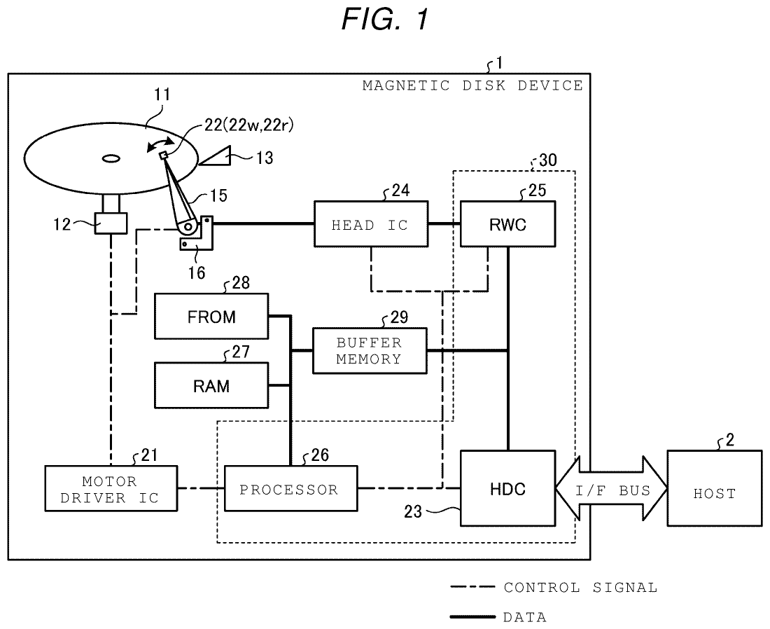

FIG. 1 is a schematic diagram illustrating an example of a configuration of a magnetic disk device 1 according to an embodiment.

The magnetic disk device 1 is connected to a host 2. The magnetic disk device 1 can receive access commands, such as write commands and read commands, from the host 2.

The magnetic disk device I includes a magnetic disk 11 having a magnetic layer formed on the surface thereof. The magnetic disk device I writes data to the magnetic disk 11 and reads data from the magnetic disk 11 in response to the access command.

Writing and reading of data is performed through a magnetic head 22. The magnetic disk device 1 includes, in addition to the magnetic disk 11, a spindle motor 12, a ramp 13, an actuator arm 15, a voice coil motor (VCM) 16, a motor driver integrated circuit (IC) 21, the magnetic head 22, a hard disk controller (HDC) 23, a head IC 24, a read/write channel (RWC) 25, a processor 26, a RAM 27, a flash read only memory (FROM) 28, and a buffer memory 29.

The magnetic disk 11 is rotated at a predetermined rotational speed by the spindle motor 12 attached coaxially thereto. The spindle motor 12 is driven by the motor driver IC 21.

The processor 26 controls the rotation of the spindle motor 12 and the rotation of the VCM 16 through the motor driver IC 21.

The magnetic head 22 performs writing and reading of data to and from the magnetic disk 11 using a write head 22w and read head 22r provided in the magnetic head 22. The magnetic head 22 is attached to the tip of the actuator arm 15. The magnetic head 22 is moved in a radial direction of the magnetic disk 11 by the VCM 16. Either one or both of the write head 22w and the read head 22r of the magnetic head 22 may be provided in plural for a single magnetic head 22.

When the magnetic disk 11 stops rotating, the magnetic head 22 is moved onto the ramp 13. The ramp 13 holds the magnetic head 22 at a position separated from the magnetic disk 11.

During a read operation, the head IC 24 amplifies and outputs a signal read by the magnetic head 22 from the magnetic disk 11, and supplies the signal to the RWC 25. During a write operation, the head IC 24 amplifies a signal corresponding to data to be written, which is supplied from the RWC 25, and supplies the amplified signal to the magnetic head 22.

The HDC 23 controls transmitting and receiving of data to and from the host 2 via an I/F bus, controls the buffer memory 29, and the like.

The buffer memory 29 is used as a buffer for data transmitted and received to and from the host 2. For example, the buffer memory 29 is used to temporarily store data to be written or data read from the magnetic disk 11.

The buffer memory 29 is configured with a volatile memory capable of high-speed operation. The type of memory that makes up the buffer memory 29 is not limited to a specific type. The buffer memory 29 may be configured with, for example, a dynamic random access memory (DRAM), a static random access memory (SRAM), or a combination of the DRAM and the SRAM. The buffer memory 29 may be configured with nonvolatile memory.

The RWC 25 performs modulation such as error correction coding on data to be written supplied from the HDC 23, and supplies the modulated data to the head IC 24. The RWC 25 also performs demodulation, including error correction processing, on a signal read from the magnetic disk 11 and supplied from the head IC 24, and outputs the demodulated signal to the HDC 23 as digital data.

The processor 26 is, for example, a central processing unit (CPU). The processor 26 is connected to the RAM 27, the FROM 28, and the buffer memory 29.

The FROM 28 is a nonvolatile memory. In the FROM 28, firmware (program data) and various operating parameters are stored. The firmware may be stored on the magnetic disk 11.

The RAM 27 is configured with, for example, a DRAM, an SRAM, or a combination of the DRAM and the SRAM. The RAM 27 is used by the processor 26 as a memory for operation. The RAM 27 is used as an area into which firmware is loaded and an area in which various management data is temporarily stored.

The processor 26 performs overall control of the magnetic disk device 1 according to the firmware stored in the FROM 28 or the magnetic disk 11. For example, the processor 26 loads the firmware from the FROM 28 or the magnetic disk 11 onto the RAM 27, and controls the motor driver IC 21, the head IC 24, the RWC 25, the HDC 23, and the like according to the loaded firmware.

The configuration including the HDC 23, the RWC 25, and the processor 26 can also be considered as a controller 30 that controls the operation of the magnetic disk device 1. The controller 30 may include other elements (such as the RAM 27, the FROM 28, or the buffer memory 29), in addition to the HDC 23, the RWC 25, and the processor 26.

The firmware program may be stored in the magnetic disk 11. Some or all of the functions of the processor 26 may be implemented by a hardware circuit such as a field-programmable gate array (FPGA) or an application specific integrated circuit (ASIC).

The number of magnetic disks 11 provided in the magnetic disk device 1 is not limited to one. The magnetic disk device 1 may include actuator arms 15 and magnetic heads 22 in numbers corresponding to the number of magnetic disks 11. Furthermore, when the magnetic disk device 1 includes a plurality of magnetic heads 22, the plurality of magnetic heads 22 may be moved together as a unit. The plurality of magnetic heads 22 may be divided into a plurality of groups that can move independently of each other.

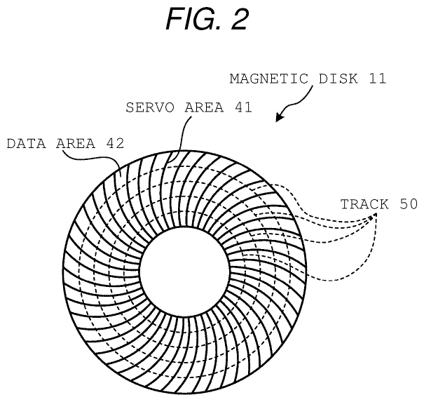

FIG. 2 is a diagram illustrating an example of a configuration of the magnetic disk 11 according to an embodiment. Servo data used for positioning the magnetic head 22 is written to the magnetic layer formed on the surface of the magnetic disk 11, for example, by a servo writer or by a process known as Self Servo Writing (SSW).

In FIG. 2, as an example of the arrangement of servo areas in which the servo data is written, servo areas 41 arranged radially are shown. In the circumferential direction, each of data areas 42 into which data can be written is provided between two servo areas 41. A plurality of concentric tracks 50 are provided in the radial direction of the magnetic disk 11. On a track 50, each data area 42 is provided with a plurality of sectors, each of which is written with data of a predetermined size. The predetermined size is a sector size.

The servo data is data used to estimate the current position of the magnetic head 22. The controller 30 acquires an estimated value of the current position of the magnetic head 22 by demodulating the servo data read from the servo area 41 by the magnetic head 22. Then, the controller 30 moves the magnetic head 22 closer to a target position based on the estimated value of the current position of the magnetic head 22. The servo areas 41 are arranged at intervals on the circumference. Therefore, the controller 30 estimates the current position of the magnetic head 22 during a time period when the magnetic head 22 passes through the servo area 41. The time period during which the current position of the magnetic head 22 is estimated, which is the time period when the magnetic head 22 passes through the servo area 41, is called a servo sampling period.

When the controller 30 accesses (writes or reads data to or from) the magnetic disk 11 using the magnetic head 22, the controller 30 first moves the magnetic head 22 in the radial direction toward a target track. The target track is the track 50 to be accessed. The operation to move the magnetic head 22 in the radial direction toward the target track is referred to as a seek operation.

If the magnetic head 22 is moved to the target track by the seek operation, residual vibration of the magnetic head 22 occurs. Even if the seek operation is completed, if the residual vibration is large, the controller 30 cannot perform access correctly.

For example, during a data write, the controller 30 determines whether the magnetic head 22 is in an on-track state (that is, a state in which the magnetic head 22 is considered to be positioned on the target track). When it is determined that the magnetic head 22 is not in the on-track state, the controller 30 immediately suspends the write. Then, the controller 30 retries the write after the magnetic disk 11 rotated once. Whether the magnetic head 22 is in the on-track state is determined by comparing a positioning error amount with a write off-track slice. The positioning error amount is a deviation amount of the magnetic head 22 from a track center of the target track, and is obtained by demodulating the servo data. When the positioning error amount exceeds the write off-track slice, the controller 30 immediately suspends the write and retries a data write. The retry of the write is started when the magnetic disk 11 rotates once and the magnetic head 22 reaches a circumferential position at which the write was suspended.

If the write is started in a state where the residual vibration is large, there is a high risk that the positioning error amount will exceed the write off-track slice and the write will be suspended. Therefore, after the seek operation, the controller 30 performs a stabilization operation of waiting until the residual vibration is sufficiently attenuated. After the stabilization operation, the controller 30 executes a write to the target track.

In the following, the seek operation and the stabilization operation will be described by illustrating the seek operation during a write operation as an example.

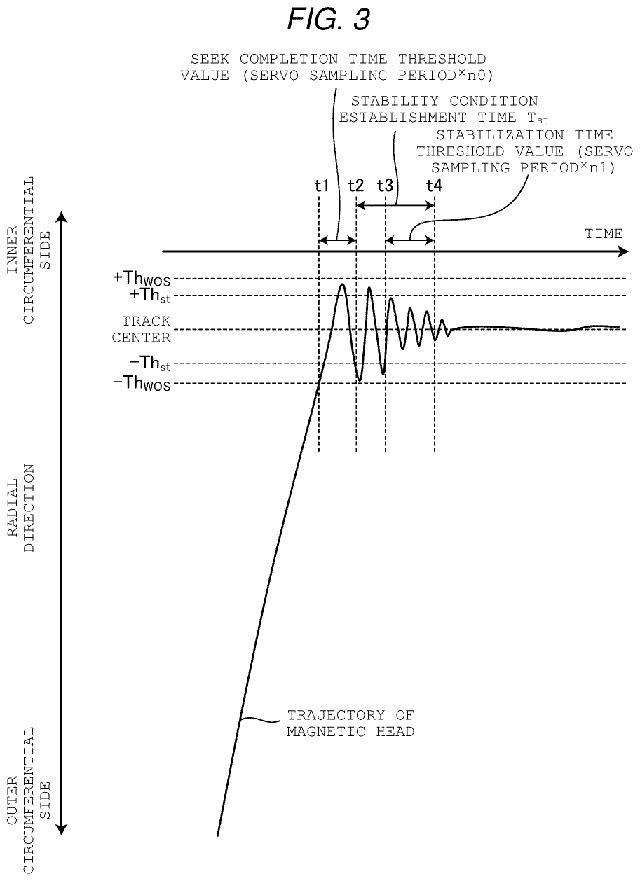

FIG. 3 is a diagram illustrating a stabilization operation according to an embodiment.

In the stabilization operation, a threshold value That is used to determine whether the residual vibration of the magnetic head 22 is sufficiently attenuated. The threshold value Thₛₜ is also referred to as a stabilization amplitude threshold value Thₛₜ. The stabilization amplitude threshold value Thₛₜ is an example of a second threshold value.

The controller 30 compares the positioning error amount with the stabilization amplitude threshold value Thₛₜ to determine whether a radial position of the magnetic head 22 is within a range from −Thₛₜ to +Thₛₜ with the track center of the target track as a reference.

In FIG. 3, the radial position is expressed with an outer circumferential side as a negative direction and an inner circumferential side as a positive direction. The setting of negative and positive directions in the radial position is not limited thereto.

In the seek operation, when a predetermined condition regarding the positioning error amount is satisfied, the controller 30 considers that the seek operation is completed and starts the stabilization operation. A condition for determining whether the seek operation is completed is referred to as a seek completion condition.

In one example, the seek completion condition is that a length of a continuous period during which the positioning error amount is maintained to be less than or equal to the write off-track slice Th_{WOS}, reaches a predetermined threshold value (referred to as a seek completion time threshold value). The seek completion condition is not limited thereto, as long as the seek completion condition is less stringent than a stabilization condition described below. A threshold value to be compared with the positioning error amount in the seek completion condition may be different from the write off-track slice Th_{WOS}. The seek completion condition may be that the magnetic head 22 crosses a predetermined radial position (for example, the track center of the target track).

In the example shown in FIG. 3, at timing t1, the positioning error amount becomes less than or equal to the write off-track slice Th_{WOS} for the first time, and in response to this, the controller 30 starts measuring the length of the continuous period during which the positioning error amount is maintained to be less than or equal to the write off-track slice Th_{WOS}. Then, at timing t2, the length of the continuous period during which the positioning error amount is maintained to be less than or equal to the write off-track slice Th_{WOS} reaches the seek completion time threshold value, and thus the controller 30 determines that the seek operation is completed. Then, the controller 30 starts the stabilization operation.

In the stabilization operation, the controller 30 measures the length of the continuous period during which the positioning error amount is maintained to be less than or equal to the stabilization amplitude threshold value Thₛₜ. When the length of the continuous period during which the positioning error amount is maintained to be less than or equal to the stabilization amplitude threshold value Thₛₜ reaches a preset time (referred to as a stabilization time threshold value), the controller 30 ends the stabilization operation and goes into a state where the write operation on the target track is possible. The stabilization time threshold value is an example of a third threshold value.

In the example shown in FIG. 3, the positioning error amount is maintained to be less than or equal to the stabilization amplitude threshold value Thₛₜ for a continuous period from timing t3 when the positioning error amount becomes less than or equal to the stabilization amplitude threshold value Thₛₜ to timing t4 when the time of stabilization time threshold value elapses. Therefore, the stabilization operation ends at timing t4.

As described above, the controller 30 acquires the positioning error amount based on the servo data read from the magnetic disk 11. That is, the controller 30 sequentially acquires the positioning error amount during the time period when the magnetic head 22 demodulates the servo data, that is, a servo sampling period.

Therefore, the controller 30 counts the number of times the positioning error amount that is less than or equal to the write off-track slice Th_{WOS} is continuously acquired, as an amount corresponding to the length of the continuous period during which the positioning error amount is maintained to be less than or equal to the write off-track slice Th_{WOS}. When the number of times the positioning error amount that is less than or equal to the write off-track slice Th_{WOS} is continuously acquired reaches a count value corresponding to the seek completion time threshold value (n0 in the example shown in FIG. 3), the controller 30 determines that the seek operation is completed.

Similarly, the controller 30 counts the number of times the positioning error amount that is less than or equal to the stabilization amplitude threshold value Thₛₜ is continuously acquired, as an amount corresponding to the length of the continuous period during which the positioning error amount is maintained to be less than or equal to the stabilization amplitude threshold value Thₛₜ. When the number of times the positioning error amount that is less than or equal to the stabilization amplitude threshold value Thₛₜ is continuously acquired reaches a count value corresponding to the stabilization time threshold value (n1 in the example shown in FIG. 3), the controller 30 determines that the stabilization operation is completed.

In this specification, the time from when the seek operation is completed to when the stabilization operation is completed is referred to as a stability condition establishment time or a stability condition establishment time Tₛₜ. In the example shown in FIG. 3, a length of a period from timing t2 to timing t4 corresponds to the stability condition establishment time Tₛₜ. Furthermore, the stabilization condition is satisfied when the length of the continuous period during which the positioning error amount is maintained to be less than or equal to the stabilization amplitude threshold value Thₛₜ reaches the stabilization time threshold value. That is, the controller 30 considers that the stabilization operation is completed when it is determined that the stabilization condition is satisfied. When the stabilization operation is completed, the controller 30 can start writing data.

The positioning error amount during the write operation, that is, a positional deviation amount of the magnetic head 22 from the track center of the target track, which is an amount expressed as a percentage when a track pitch is 100%, is referred to as a write off-track amount.

In the example shown in FIG. 3, although the write off-track slice Th_{WOS} is larger than the stabilization amplitude threshold value Thₛₜ, a magnitude relationship between the write off-track slice Th_{WOS} and the stabilization amplitude threshold value That is not limited thereto. The write off-track slice Th_{WOS} and the stabilization amplitude threshold value Thₛₜ may be the same.

As described above, when writing data to the target track, the track 50 adjacent to the target track is influenced by the ATI. The influence of the ATI received by the track 50 is accumulated in the track 50. If the influence of the ATI accumulated in the track 50 becomes too large, data stored in the track 50 becomes difficult to read.

The controller 30 executes a rewrite operation before it becomes difficult to read data from the track 50 due to the influence of the ATI. The rewrite operation is an operation to write all data stored in the track 50 again to the track 50. Such a rewrite operation executed to prevent data from becoming difficult to read due to the influence of the ATI is referred to as a refresh operation, in the sense that the rewrite operation is an operation for restoring (in other words, refreshing) a state of the track 50 from a state in which the influence of the ATI is accumulated to a state in which the influence of the ATI is not accumulated.

The controller 30 estimates a degree of influence of the ATI accumulated in each track 50 using an ATI counter. A value of the ATI counter is considered as numerical information indicating the degree of influence of the ATI accumulated in the track 50 corresponding to the ATI counter. The controller 30 executes the refresh operation on the track 50 before the value of the ATI counter exceeds a threshold value (hereinafter, referred to as a read-guarantee value) corresponding to an upper limit value of a range in which expected data can be acquired from the track 50.

The read-guarantee value is an example of a first threshold value. The plurality of tracks 50 are an example of a plurality of storage areas arranged in the radial direction. Each storage area is a unit for which an ATI counter is provided. The storage area, which is the unit for which the ATI counter is provided, is not limited to one track 50. The ATI counter may be provided for each storage area including two or more tracks 50 arranged consecutively in the radial direction.

In the example described below, the ATI counter is provided for each track 50. An ATI counter for estimating the influence of the ATI accumulated in a certain track 50 is referred to as an ATI counter of the track 50.

The influence of the ATI may be exerted not only on adjacent tracks but also on the tracks 50 more than one track away from the target track. Therefore, the controller 30 also adds an increment to the ATI counters of the tracks 50 more than one track away from the target track. That is, the controller 30 also adds an increment to the ATI counters of the tracks 50 in the vicinity of the target track.

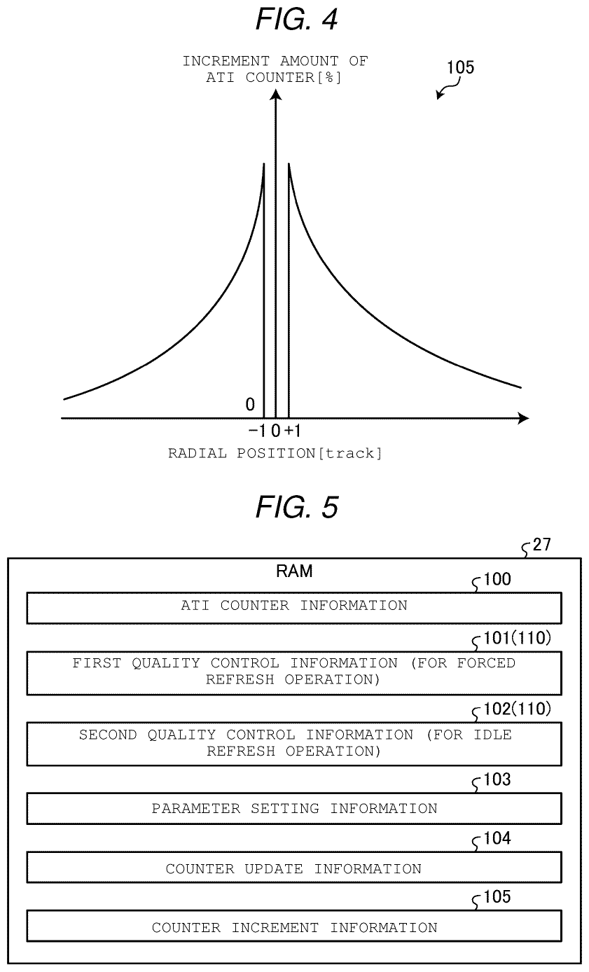

FIG. 4 is a diagram illustrating an increment amount of the ATI counter according to an embodiment. The horizontal axis in FIG. 4 indicates a radial position with a position of the target track as the origin. Here, the radial position is expressed as numerical information in units of tracks 50. The vertical axis indicates an increment amount of the ATI counter of the track 50 at the position indicated on the horizontal axis. For normalization purposes, an increment amount of the ATI counter for the track 50 in FIG. 4 is expressed as a percentage obtained by dividing the increment amount by the read-guarantee value set for that track 50.

As shown in the FIG. 4, the increment amount of the ATI counter is the largest in the adjacent tracks, and the farther the tracks are from the target track, the smaller the increment amount of the ATI counter is. Information expressing the increment amount for each track 50 as a percentage of the read-guarantee value shown in FIG. 4 is recorded as setting information in counter increment information 105, which will be described below.

There are a plurality of types of refresh operations. The plurality of types of refresh operations include a forced refresh operation and an idle refresh operation. The plurality of types of refresh operations have different trigger for execution.

The forced refresh operation is a refresh operation that is executed when a value of the ATI counter reaches the read-guarantee value. Even if the controller 30 is in the middle of processing a command from the host 2, if there is an ATI counter whose value reaches the read-guarantee value, the controller 30 suspends processing of the command from the host 2 and executes a refresh operation with the track 50 corresponding to that ATI counter as a target track.

The idle refresh operation is a refresh operation that is started when the magnetic disk device 1 is in an idle state. The idle state is a state in which all commands received from the host 2 have been processed and there are no unprocessed commands. When the magnetic disk device 1 is in the idle state, the controller 30 sequentially selects the tracks 50 and executes the refresh operation on the selected track 50 even if there is no ATI counter whose value reaches the read-guarantee value. The method of selecting the track 50 is freely selected. For example, the controller 30 may select the tracks 50 as targets for the refresh operation in order from the track 50 having the largest value of the ATI counter.

The plurality of types of refresh operations may include any type of refresh operation. For example, the plurality of types of refresh operations may include a periodic refresh operation that is periodically started up regardless of whether a command from the host 2 is being processed.

A technique to be compared with the embodiment will be described. The technique to be compared with the embodiment will be referred to as a comparative example.

According to the comparative example, upon completion of the refresh operation, the controller clears the ATI counter of the track on which the refresh operation was performed to zero. Then, in response to a write to a track in the vicinity of the track on which the refresh operation was performed, the controller adds an increment to the ATI counter of the track on which the refresh operation was performed, where the increment of the addition starts from 0.

In recent years, as magnetic disk recording density has increased, the quality of the write operation as part of the refresh operation (hereinafter, referred to as write quality) has a greater influence on the activation of the next refresh operation. For example, in a write operation executed as part of a refresh operation, when the write off-track amount is large, the influence of the ATI received by the adjacent tracks of the target track becomes large. Furthermore, the target track itself is also greatly influenced by the ATI caused by the write to the adjacent tracks that are subsequently executed.

However, according to the comparative example, the ATI counter of the target track is reset to zero regardless of the write quality in the refresh operation. Therefore, a discrepancy occurs between the value of the ATI counter and the actual influence of the ATI received. Since the value of the ATI counter cannot be said to accurately represent the influence of the ATI received by the track, a safety measure such as setting a read-guarantee value with a large margin should be taken, which may result in an unnecessarily high execution frequency of the refresh operations.

Furthermore, in order to reduce the execution frequency of refresh operations, making the write quality of the refresh operation as high as possible is required. However, the forced refresh operation is executed by suspending the processing of the command from the host. Therefore, from the viewpoint of response performance to the host, the forced refresh operation is required not only to improve write quality but also to complete the refresh operation as quickly as possible. In contrast, since the idle refresh operation is executed when the magnetic disk device is in an idle state, it is possible to use an ample amount of time compared to the forced refresh operation. Therefore, in the idle refresh operation, an ample amount of time can be used to improve the write quality.

However, according to the comparative example, the write quality is not controlled according to the type of refresh operation. Therefore, there is room for improvement in the refresh operation.

In the embodiment, the controller 30 changes the control of the write quality depending on the type of refresh operation. Furthermore, the controller 30 monitors actual write quality during the refresh operation, and variably updates the value of the ATI counter of the target track based on the actual write quality.

FIG. 5 is a diagram illustrating an example of management information stored in the RAM 27 according to an embodiment. In the RAM 27, ATI counter information 100, first quality control information 101, second quality control information 102, parameter setting information 103, counter update information 104, and counter increment information 105 are stored.

The ATI counter information 100 is information in which the value of the ATI counter for each track 50 is recorded.

The first quality control information 101 is information for managing quality of the forced refresh operation. The second quality control information 102 is information for managing quality of the idle refresh operation. The second quality control information 102 has a similar configuration to that of the first quality control information 101.

The first quality control information 101 and the second quality control information 102 may be collectively referred to as quality control information 110.

The parameter setting information 103 is information in which parameter setting values are recorded for each type of refresh operation. Specific examples of the setting values recorded in the parameter setting information 103 will be described below.

The counter update information 104 will also be described below.

The counter increment information 105 is information in which an increment amount of the ATI counter for each track 50 with the target track as a reference is recorded.

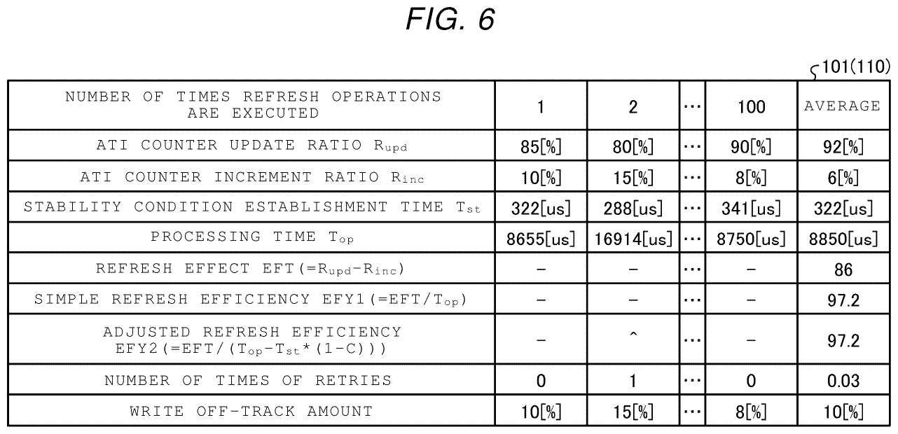

FIG. 6 is a table showing an example of a configuration of the quality control information 110 according to the embodiment. In FIG. 6, an example of a configuration of the first quality control information 101 is shown as an example of the quality control information 110.

Every time the refresh operation is executed, an ATI counter update ratio R_{upd}, an ATI counter increment ratio R_{inc}, a stability condition establishment time Tₛₜ, the processing time Tₒₚ, and a write off-track amount are acquired and recorded in the first quality control information 101.

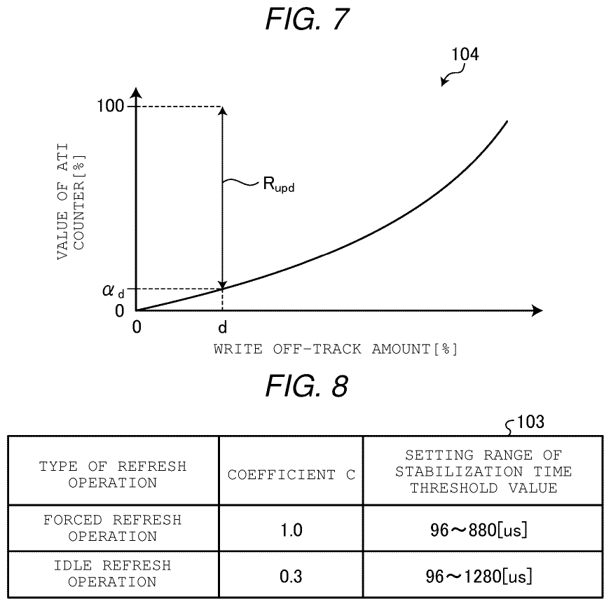

FIG. 7 is a graph showing the ATI counter update ratio R_{upd} according to the embodiment.

If the write off-track amount when the refresh operation is performed is 0%, the controller 30 sets the value of the ATI counter of the target track to zero. If the write off-track amount when the refresh operation is performed is greater than 0%, the controller 30 updates the value of the ATI counter of the target track to a value corresponding to the write off-track amount.

When the controller 30 executes the refresh operation, the controller variably updates the value of the ATI counter of the target track according to the actual write quality in the refresh operation, here the write off-track amount.

FIG. 7 shows updated values of the write off-track amount and the ATI counter of the target track of the refresh operation in response to the refresh operation.

The read-guarantee value may vary depending on the track 50. Therefore, the updated value in response to the refresh operation is expressed as a percentage divided by the read-guarantee value for normalization. The relationship shown in FIG. 7 is recorded in the counter update information 104 as setting information. The controller 30 determines the value of the ATI counter of the target track after the refresh operation based on the relationship recorded in the counter update information 104. The controller 30 may also use the counter update information 104 in normal write operations.

The ATI counter update ratio R_{upd} is numerical information expressed as a percentage by dividing a value, which is obtained by subtracting the updated value of the ATI counter from the read-guarantee value, by the read-guarantee value for normalization.

For example, when the write off-track amount is “d”, the controller 30 updates the value of the ATI counter of the target track to α_{d} in a normalized representation based on the relationship shown in FIG. 7. In this case, the controller 30 acquires a value obtained by calculating (100−α_{d}) as the ATI counter update ratio R_{upd}.

Even if the value of the ATI counter of the target track at the start of the refresh operation is less than the read-guarantee value, the ATI counter update ratio R_{upd} is calculated with the read-guarantee value as a reference. As shown in FIG. 7, the lower the actual write quality during the refresh operation (that is, the greater the write off-track amount), the larger the ATI counter value of the target track is updated. Therefore, the higher the actual write quality during the refresh operation (that is, the smaller the write off-track amount), the closer the ATI counter update ratio R_{upd} is to 100%.

Description will be given referring back to FIG. 6.

The ATI counter increment ratio R_{inc} is a value, which is obtained by normalizing the increment amount to the ATI counter of each track 50 in the vicinity of the target track, which is incremented in response to the refresh operation, by the read-guarantee value for each track 50 and then taking the sum. The controller 30 calculates the ATI counter increment ratio R_{inc} based on the relationship shown in FIG. 4. For the ATI counters of adjacent tracks among the tracks in the vicinity of the target track, the controller 30 may increase the increment amount according to the write off-track amount.

As described above, the stability condition establishment time Tₛₜ is the time from when the seek operation is completed to when the stabilization operation is completed.

The processing time Tₒₚ is the time from when the seek operation is completed to when the refresh operation is completed. When retry of a write is performed in the refresh operation, the time including the time required for the write retry is acquired as the processing time Tₒₚ.

As described above, the write off-track amount is an amount expressed as a ratio of the positioning error amount of the magnetic head 22 when the track pitch is set to 100%. The positioning error amount of the magnetic head 22 may vary during writing to the target track. The controller 30 calculates the write off-track amount using the maximum positioning error amount during writing to the target track. The method of calculating the write off-track amount is not limited thereto.

When the controller 30 performs the refresh operation a predetermined number of times (100 times in the example shown in FIG. 6), the controller 30 calculates an average value for each of the ATI counter update ratio R_{upd}, the ATI counter increment ratio R_{inc}, the stability condition establishment time Tₛₜ, the processing time Tₒₚ, and the write off-track amount recorded in the first quality control information 101 for each forced refresh operation. Then, the controller 30 calculates a refresh effect EFT, a simple refresh efficiency EFY1, and an adjusted refresh efficiency EFY2 based on the respective average values. Then, the controller 30 records the calculated refresh effect EFT, simple refresh efficiency EFY1, and adjusted refresh efficiency EFY2 in the first quality control information 101.

The refresh effect EFT is numerical information obtained by subtracting the ATI counter increment ratio R_{inc} from the ATI counter update ratio R_{upd}. The refresh effect EFT indicates how much the influence of the ATI accumulated in each track 50 can be reduced by the refresh operation for the entire magnetic disk device I as a whole. That is, the refresh effect EFT is a value corresponding to the effect of the refresh operation.

The simple refresh efficiency EFY1 is numerical information obtained by dividing the refresh effect EFT by the processing time Tₒₚ. The simple refresh efficiency EFY1 indicates the refresh effect EFT per unit time. Here, as an example, the simple refresh efficiency EFY1 is expressed as a percentage.

The adjusted refresh efficiency EFY2 indicates the refresh effect EFT per unit time when a weight of the stability condition establishment time Tₛₜ included in the processing time Tₒₚ is adjusted based on the type of refresh operation. Specifically, the adjusted refresh efficiency EFY2 is obtained by the calculation of the following Equation (1).

$$EFY 2 = EFT / ( {T}_{o p} - {T}_{st} * ( 1 - C ) ) \qquad ( 1 )$$

In Equation (1), C is a coefficient prepared for the type of refresh operation. In the denominator of the right side of Equation (1), the weight of the component of the stability condition establishment time Tₛₜ in the processing time Tₒₚ is adjusted using the coefficient C.

The controller 30 controls the write quality in the refresh operation by controlling the stabilization time threshold value. The stabilization time threshold value influences not only the actual write quality but also the stability condition establishment time Tₛₜ.

Specifically, if the stabilization time threshold value is increased, since the residual vibration of the magnetic head 22 after the completion of the seek operation can be further reduced, the actual write quality observed as the write off-track amount becomes higher. However, if the stabilization time threshold value is increased, the time required until the stabilization condition is satisfied, that is, the stability condition establishment time Tₛₜ, becomes longer. If the stabilization time threshold value is decreased, the opposite phenomenon occurs compared to when the stabilization time threshold value is increased.

As described above, with respect to the forced refresh operation, both reduction of the time required for the refresh operation and improvement of the write quality are required. In contrast, with respect to the idle refresh operation, the need to reduce the time required for the refresh operation is not as high as that of the forced refresh operation.

Therefore, the coefficient C is set for each of the forced refresh operation and the idle refresh operation so that the weight acting on the stability condition establishment time Tₛₜ is smaller in the case of the idle refresh operation compared to the case of the forced refresh operation. Therefore, by using the adjusted refresh efficiency EFY2, in the case of the idle refresh operation, it is possible to perform evaluation that places emphasis on the write quality compared to the case of the forced refresh operation. Furthermore, by using the adjusted refresh efficiency EFY2, in the case of the forced refresh operation, it is possible to perform evaluation that places emphasis on the time required for the refresh operation compared to the case of the idle refresh operation.

The refresh effect EFT is an example of a second value. The denominator on the right side of Equation (1), that is, the time from the completion of the stabilization operation including the stability condition establishment time to which the weight is applied to the completion of the refresh operation, is an example of a third value. The denominator on the right side of Equation (1) is expressed as the adjusted processing time. The adjusted refresh efficiency EFY2 is an example of a fourth value.

A plurality of sets including the first quality control information 101 and second quality control information 102 may be stored in the RAM 27. For example, the controller 30 may divide a recording surface of the magnetic disk 11 into a plurality of zones in the radial direction and manage the first quality control information 101 and the second quality control information 102 for each zone. Alternatively, the controller 30 may manage the first quality control information 101 and the second quality control information 102 for each magnetic head 22. Here, it is assumed that one set including the first quality control information 101 and the second quality control information 102 is stored in the RAM 27.

FIG. 8 is a table showing an example of a configuration of the parameter setting information 103 according to the embodiment. In the parameter setting information 103, for each type of refresh operation, a set value of the coefficient C and a setting range of the stabilization time threshold value are recorded.

In the example shown in FIG. 8, for the forced refresh operation, the coefficient C is set to 1.0. Therefore, according to Equation (1), the adjusted refresh efficiency EFY2 has the same value as the simple refresh efficiency EFY1.

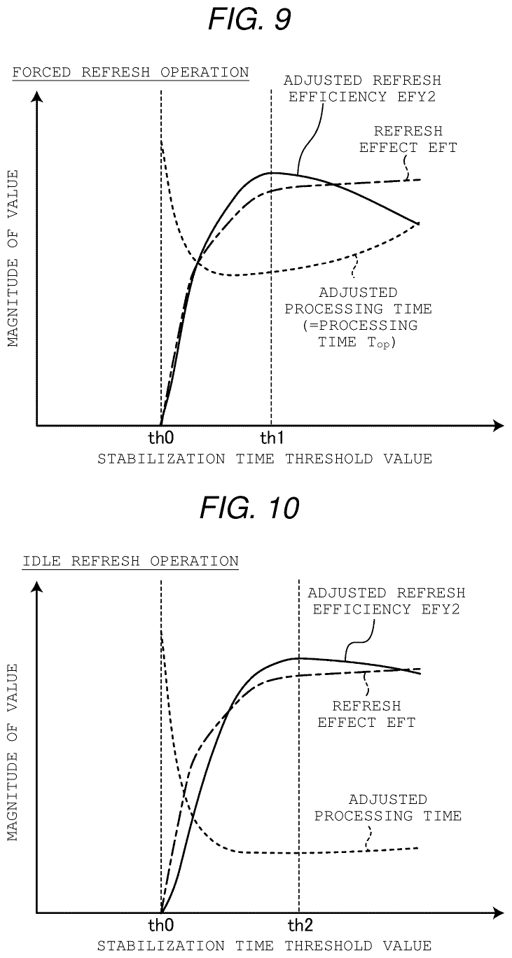

In contrast, for the idle refresh operation, the coefficient C is set to 0.3. Therefore, according to Equation (1), the component of the stability condition establishment time Tₛₜ in the processing time Tₒₚ is multiplied by 0.7. Therefore, compared to the forced refresh operation, it is possible to perform an evaluation that places emphasis on write quality. A specific example will be described with reference to FIGS. 9 and 10.

FIG. 9 is a graph showing an example of the relationship between the stabilization time threshold value and the adjusted refresh efficiency EFY2 in a forced refresh operation according to an embodiment. FIG. 10 is a graph showing an example of the relationship between the stabilization time threshold value and the adjusted refresh efficiency EFY2 in an idle refresh operation according to an embodiment. In FIGS. 9 and 10, the horizontal axis indicates the stabilization time threshold value. The vertical axis indicates the magnitude of respective values of the adjusted refresh efficiency EFY2, the refresh effect EFT, and the adjusted processing time. The adjusted processing time indicates the processing time Tₒₚ after the weight is applied to the stability condition establishment time Tₛₜ. That is, the adjusted processing time is a value of the denominator of the right side of Equation (1). The set value of the coefficient C illustrated in FIG. 8 is applied to the calculation of the adjusted refresh efficiency EFY2 and the adjusted processing time shown in FIGS. 9 and 10.

The larger the stabilization time threshold value, the better the write quality. Therefore, as shown in FIGS. 9 and 10, the refresh effect EFT improves as the stabilization time threshold value increases. If the stabilization time threshold value is too small, the rewrites of write operations occur frequently, and accordingly, it is impossible to perform the refresh operation. Therefore, the refresh effect EFT can be obtained from when the stabilization time threshold value becomes equal to or greater than a certain value (th0 in FIGS. 9 and 10).

In the forced refresh operation, the adjusted processing time is equal to the processing time Tₒₚ. As shown in FIG. 9, the adjusted processing time decreases as the stabilization time threshold value becomes greater than th0, and then increases as the stabilization time threshold value becomes greater when the stabilization time threshold value exceeds a certain value. The adjusted refresh efficiency EFY2 has a maximum value when the stabilization time threshold value is th1.

In the idle refresh operation, as shown in FIG. 10, the adjusted processing time decreases as the stabilization time threshold value becomes greater than th0, and then increases as the stabilization time threshold value becomes greater when the stabilization time threshold value exceeds a certain value. However, the gradient of the adjusted processing time when the adjusted processing time increases is gentler than that in the forced refresh operation. As a result, the adjusted refresh efficiency EFY2 has a maximum value when the stabilization time threshold value is th2, which is greater than th1.

In the example shown in FIG. 9, the controller 30 sets th1, at which the adjusted refresh efficiency EFY2 is maximized, as the stabilization time threshold value for the forced refresh operation. In the example shown in FIG. 10, the controller 30 sets th2, at which the adjusted refresh efficiency EFY2 is maximized, as the stabilization time threshold value for the idle refresh operation.

The stabilization time threshold value is defined as a numerical value that is an integer multiple of the servo sampling period. The controller 30 shifts the stabilization time threshold value by a predetermined pitch width each time the adjusted refresh efficiency EFY2 is acquired. The predetermined pitch width is, for example, a servo sampling period. The predetermined pitch width may be two or more servo sampling periods. The controller 30 shifts the stabilization time threshold value by a predetermined pitch width for each of the forced refresh operation and the idle refresh operation. Then, the controller 30 adjusts the stabilization time threshold value for the forced refresh operation so that the stabilization time threshold value is close to th1. The controller 30 adjusts the stabilization time threshold value for the idle refresh operation so that the stabilization time threshold value is close to th2.

Subsequently, the operation of the magnetic disk device 1 will be described.

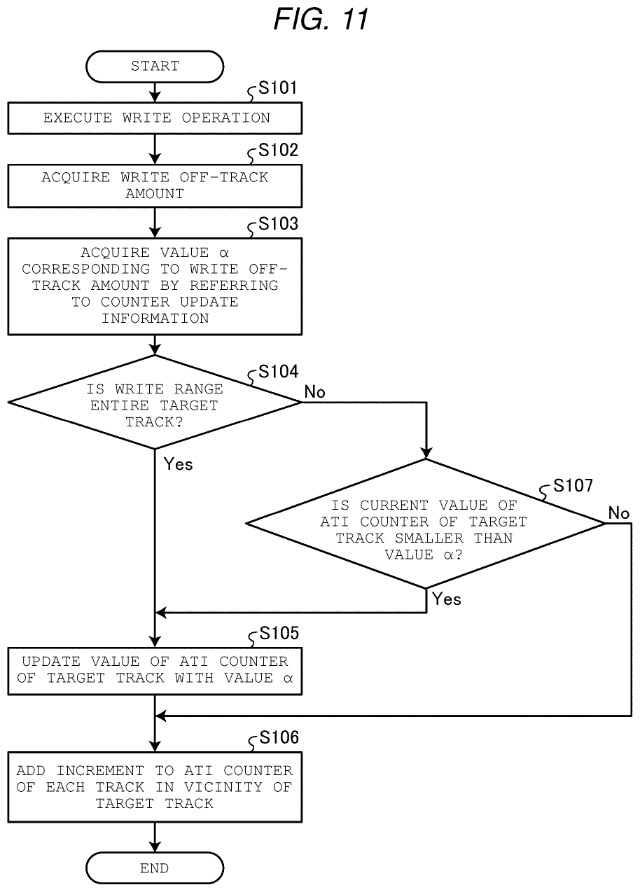

FIG. 11 is a flowchart showing an example of a series of operations related to the write operation according to the embodiment.

First, the controller 30 executes a write operation on a target track (S101). A write off-track amount when executing processing of S101 is acquired (S102). The controller 30 acquires a value (denoted as a) corresponding to the write off-track amount acquired in S102 by referring to counter update information 104 (S103).

The controller 30 determines whether a write range is the entire target track (S104).

When it is determined that the write range is the entire target track (Yes in S104), the controller 30 updates a value of an ATI counter of the target track with the value α (S105). Furthermore, the controller 30 adds an increment to the value of the ATI counter of each track 50 in the vicinity of the target track according to counter increment information 105 (S106). Then, the series of operations ends.

When it is determined that the write range is not the entire target track (No in S104), that is, when the write range is a part of the target track, the controller 30 determines whether the current value of the ATI counter of the target track is smaller than the value α (S107). When it is determined that the current value of the ATI counter of the target track is smaller than the value α (Yes in S107), control transitions to S105.

When it is determined that the current value of the ATI counter of the target track is not smaller than the value α (No in S107), control transitions to S106.

In this way, in the write operation, the controller 30 may update the value of the ATI counter of the target track depending on the write quality. By variably updating the value of the ATI counter of the target track depending on the write quality in the write operation, it becomes possible to reduce a discrepancy between the value of the ATI counter and the actual influence of the ATI received by the track 50.

In the example shown in FIG. 11, when the current value of the ATI counter of the target track is equal to the value α, control transitions to S106. When the current value of the ATI counter of the target track is equal to the value α, control may transition to S105.

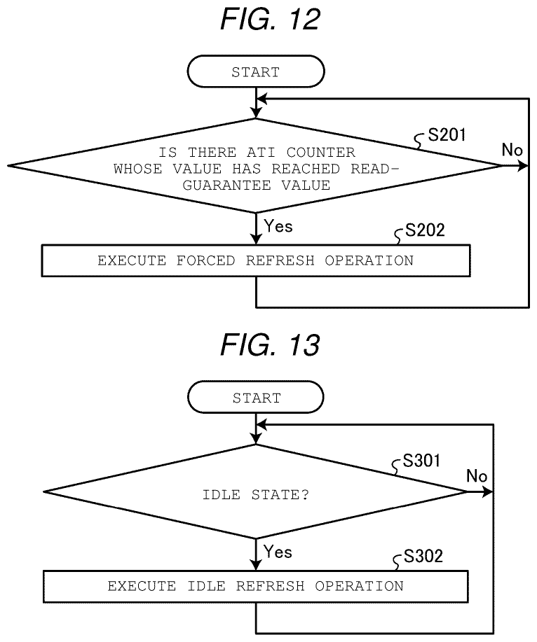

FIG. 12 is a flowchart showing an example of a trigger for executing a forced refresh operation according to an embodiment.

The controller 30 monitors ATI counter information 100 and determines whether there is an ATI counter whose value reaches a read-guarantee value (S201). When it is determined that there is the ATI counter whose value reaches the read-guarantee value (Yes in S201), the controller 30 executes a forced refresh operation on the track 50 corresponding to the ATI counter whose value reaches the read-guarantee value (S202). Even if the controller 30 is currently executing a command from the host 2, the controller 30 suspends processing of the command from the host 2 and executes the forced refresh operation. Then, the controller 30 executes processing of S201 again.

When it is determined that there is no ATI counter whose value reaches the read-guarantee value (No in S201), the controller 30 executes the processing of S201 again.

FIG. 13 is a flowchart showing an example of a trigger for executing an idle refresh operation according to an embodiment.

The controller 30 determines whether the magnetic disk device 1 is in an idle state (S301). When it is determined that the magnetic disk device 1 is in the idle state (Yes in S301), the controller 30 executes an idle refresh operation (S302). Then, the controller 30 executes processing of S301 again. When it is determined that the magnetic disk device 1 is not in the idle state (No in S301), the controller 30 executes the processing of S301 again.

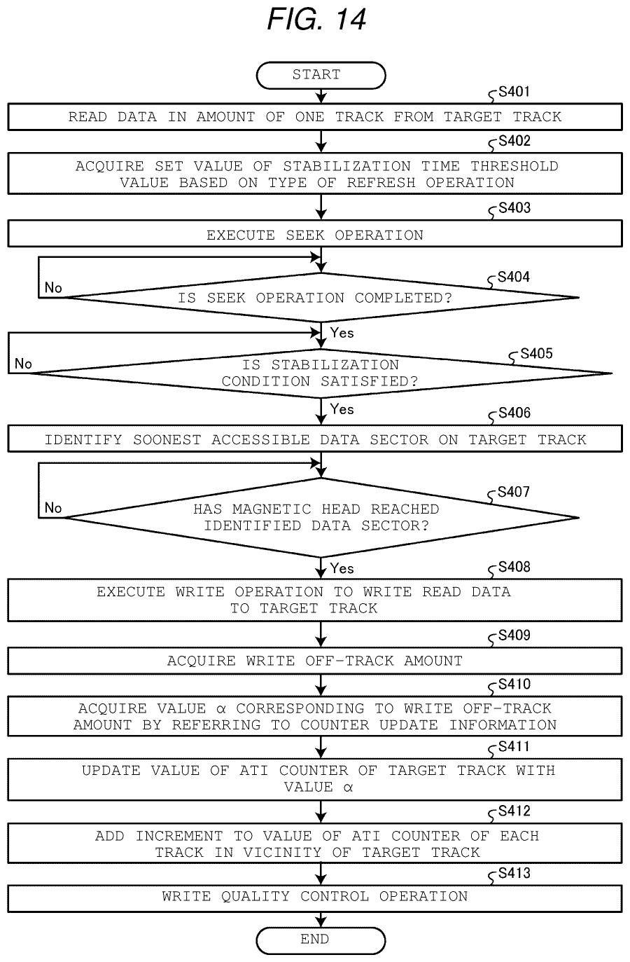

FIG. 14 is a flowchart showing an example of a series of operations related to a refresh operation according to an embodiment.

First, the controller 30 reads data in an amount of one track from the target track (S401). The controller 30 temporarily stores the data in an amount of one track read from the target track in, for example, the RAM 27 or the buffer memory 29.

Processing of S401 can be completed in advance. For example, in an idle refresh operation, when a command is received from the host 2 after execution of S401, the controller 30 may suspend subsequent processing (specifically, the operations in and after S403) and execute processing of the command. Then, after completing the processing of the command, the controller 30 may resume subsequent operations (specifically, the operation in and after S403).

After S401, the controller 30 executes a write operation as part of the refresh operation.

Specifically, the controller 30 acquires a set value of the stabilization time threshold value according to the type of refresh operation to be executed (S402). The controller 30 executes a seek operation to move the magnetic head 22 (more specifically, the write head 22w) to the target track (S403). Then, the controller 30 determines whether the seek operation is completed (S404). In S404, the controller 30 determines whether a seek completion condition is satisfied. When it is determined that the seek operation is not completed (No in S404), the controller 30 executes processing of S404 again.

When it is determined that the seek operation is completed (Yes in S404), the controller 30 starts a stabilization operation. The controller 30 uses the set value of the stabilization time threshold value acquired in S402 to determine whether the stabilization condition is satisfied (S405). When it is determined that the stabilization condition is not satisfied (No in S405), the controller 30 executes processing of S405 again.

When it is determined that the stabilization condition is satisfied (Yes in S405), the controller 30 identifies the soonest accessible data sector on the target track (S406). Then, the controller 30 waits until the magnetic head 22 reaches the identified data sector (No in S407).

If the magnetic head 22 reaches the identified data sector (Yes in S407), the controller 30 executes a write operation to write data in an amount of one track read by the processing of S401 to the target track (S408).

The controller 30 acquires a write off-track amount during processing of S408 (S409). Then, the controller 30 acquires a value α corresponding to the write off-track amount acquired in S409 by referring to counter update information 104 (S410). The controller 30 updates the value of the ATI counter of the target track with the value α (S411). Furthermore, the controller 30 adds an increment to the value of the ATI counter of each track 50 in the vicinity of the target track according to counter increment information 105 (S412).

The controller 30 executes a write quality control operation (S413), and the series of operations ends.

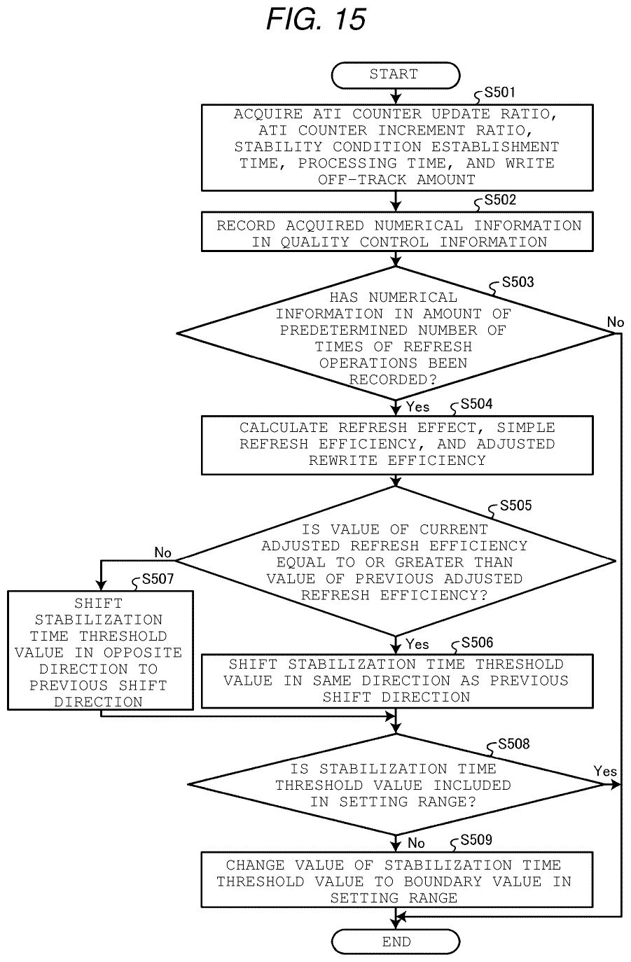

FIG. 15 is a flowchart showing an example of the write quality control operation according to an embodiment.

The controller 30 acquires an ATI counter update ratio R_{upd}, an ATI counter increment ratio R_{inc}, a stability condition establishment time Tₛₜ, a processing time Tₒₚ, and a write off-track amount (S501). The controller 30 records the acquired numerical information in quality control information 110 (S502). The controller 30 records numerical information acquired in response to the forced refresh operation in first quality control information 101. The controller 30 records numerical information acquired in response to the idle refresh operation in second quality control information 102.

The controller 30 determines whether numerical information in an amount of a predetermined number of times of refresh operations was recorded in any of the quality control information 110 (S503). When it is determined that the numerical information for a predetermined number of times of refresh operations was not recorded in any of the quality control information 110 (No in S503), the write quality control operation ends.

When it is determined that the numerical information for a predetermined number of times of refresh operations was recorded in any of the quality control information 110 (Yes in S503), the controller 30 calculates a refresh effect EFT, a simple refresh efficiency EFY1, and an adjusted refresh efficiency EFY2 based on the numerical information in an amount of the predetermined number of times of refresh operations (S504).

The controller 30 determines whether the value of the current adjusted refresh efficiency EFY2 is equal to or greater than the value of the previous adjusted refresh efficiency EFY2 (S505).

When it is determined that the value of the current adjusted refresh efficiency EFY2 is equal to or greater than the value of the previous adjusted refresh efficiency EFY2 (Yes in S505), the controller 30 shifts a stabilization time threshold value by a predetermined pitch width in the same direction as the previous shift direction (S506).

When it is determined that the current adjusted refresh efficiency EFY2 is not equal to or greater than the previous adjusted refresh efficiency EFY2 (No in S505), the controller 30 shifts the stabilization time threshold value by the predetermined pitch width in the opposite direction to the previous shift direction (S507).

When the stabilization time threshold value was previously shifted by the processing in S506 or S507, the controller 30 stores the direction in which the stabilization time threshold value is shifted, that is, whether the stabilization time threshold value is shifted in a positive direction or a negative direction. In the current processing of S506 or S507, the controller 30 determines the current shift direction based on the stored previous shift direction.

As described above, the predetermined pitch width is freely selected. The predetermined pitch width may be, for example, one servo sampling period.

After the processing of S506 or S507, the controller 30 determines whether the stabilization time threshold value is included in a setting range recorded in parameter setting information 103 (S508). When it is determined that the stabilization time threshold value is not included in the setting range recorded in the parameter setting information 103 (S508), the controller 30 changes a value of the stabilization time threshold value to a boundary value of the setting range (S509). Then, the write quality control operation ends.

When it is determined that the stabilization time threshold value is included in the setting range recorded in the parameter setting information 103 (Yes in S508), processing of S509 is skipped and the write quality control operation ends.

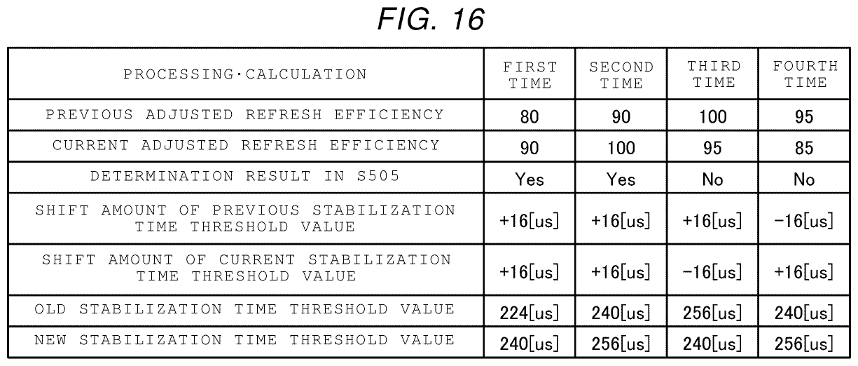

FIG. 16 is a table showing an example of calculation in the write quality control operation according to the embodiment. In the example shown in FIG. 16, calculations when the series of processing in S504 and subsequent processing shown in FIG. 15 is executed four times are shown.

In the first processing, the previous adjusted refresh efficiency EFY2 is 80, and the current adjusted refresh efficiency EFY2 is 90. Therefore, the determination result in S505 is a positive determination. That is, the stabilization time threshold value is shifted by a predetermined pitch width in the same direction as the previous shift direction. The previous shift amount of the stabilization time threshold value was +16 (us). Here, the stabilization time threshold value is shifted by a predetermined pitch width of 16 (us). Therefore, the controller 30 sets the current shift amount of the stabilization time threshold value to +16 (us). Since the old stabilization time threshold value is assumed to be 224 (us), the controller 30 sets 240 (us), which is obtained by adding 16 (us) to the old stabilization time threshold value, as a new stabilization time threshold value.

In the second processing, the previous (that is, first) adjusted refresh efficiency EFY2 is 90, and the current adjusted refresh efficiency EFY2 is 100. Therefore, the determination result in S505 is a positive determination. That is, the stabilization time threshold value is shifted by a predetermined pitch width in the same direction as the previous shift direction. The previous shift amount of the stabilization time threshold value was +16 (us). Therefore, the controller 30 sets the current shift amount of the stabilization time threshold value to +16 (us). Since the old stabilization time threshold value is assumed to be 240 (us), the controller 30 sets 256 (us), which is obtained by adding 16 (us) to the old stabilization time threshold value, as a new stabilization time threshold value.

In the third processing, the previous (that is, the second) adjusted refresh efficiency EFY2 is 100, and the current adjusted refresh efficiency EFY2 is 95. Therefore, the determination result in S505 is a negative determination. That is, the stabilization time threshold value is shifted by a predetermined pitch width in the opposite direction to the previous shift direction. The previous shift amount of the stabilization time threshold value was +16 (us). Therefore, the controller 30 sets the current shift amount of the stabilization time threshold value to −16 (us). Since the old stabilization time threshold value is assumed to be 256 (us), the controller 30 sets 240 (us), which is obtained by subtracting 16 (us) from the old stabilization time threshold value, as a new stabilization time threshold value.

In the fourth processing, the previous (that is, the third) adjusted refresh efficiency EFY2 is 95, and the current adjusted refresh efficiency EFY2 is 85. Therefore, the determination result in S505 is a negative determination. That is, the stabilization time threshold value is shifted by a predetermined pitch width in the opposite direction to the previous shift direction. The previous shift amount of the stabilization time threshold value was −16 (us). Therefore, the controller 30 sets the current shift amount of the stabilization time threshold value to +16 (us). Since the old stabilization time threshold value is assumed to be 240 (us), the controller 30 sets 256 (us), which is obtained by adding 16 (us) to the old stabilization time threshold value, as a new stabilization time threshold value.

In this way, the controller 30 adjusts the stabilization time threshold value at every predetermined pitch width so that the stabilization time threshold value approaches a value at which the adjusted refresh efficiency EFY2 takes the maximum value.

In the example described above, the controller 30 adjusted the stabilization time threshold value among the stabilization conditions. The controller 30 may be configured to adjust the stabilization amplitude threshold value Thₛₜ among the stabilization conditions.

The controller 30 may also be configured to adjust the setting range of the stabilization time threshold value. For example, when an average value of the number of times of retries recorded in the quality control information 110 is smaller than a predetermined threshold value, a lower limit value of the setting range of the stabilization time threshold value may be lowered, and when the average value is greater than the predetermined threshold value, the lower limit of the setting range of the stabilization time threshold value may be raised.

### SUMMARY

According to the embodiment, the controller 30 adds an increment to a value of a counter corresponding to a track 50 in the vicinity of a track 50 on which writing was performed among a plurality of tracks 50 in response to a write operation (see, for example, S106 in FIG. 11). The controller 30 executes a refresh operation in response to each of at least two triggers (see, for example, FIG. 12 and FIG. 13). For example, the refresh operation includes a forced refresh operation and an idle refresh operation, each of which is triggered by a different trigger. In the refresh operation, the controller 30 executes a seek operation to move a magnetic head 22 to a target track, a stabilization operation to wait for attenuation of residual vibration of the magnetic head 22 after the seek operation is completed, and a rewrite of all data of the target track to the target track after the stabilization operation is completed (see, for example, S403 to S408 in FIG. 14). The controller 30 decrements a value of a counter of the target track in response to the refresh operation (see, for example, S410 and S411 in FIG. 14). The controller 30 adds an increment to a value of an ATI counter of the track 50 in the vicinity of the target track in response to the refresh operation (see, for example, S412 in FIG. 14). The stabilization operation includes an operation to determine whether the stabilization operation is completed depending on whether the stabilization condition is satisfied (see, for example, FIG. 3 and S405 in FIG. 14). The stabilization condition differs for each trigger of the refresh operation (see, for example, FIG. 9 and FIG. 10).

Therefore, it is possible to control the write quality in accordance with the type of refresh operation. That is, it is possible to suitably execute the rewrite operation caused by the ATI.

According to the embodiment, the forced refresh operation is executed as the value of the ATI counter reaches the read-guarantee value. An idle refresh operation is executed when a magnetic disk device 1 enters an idle state.

According to the embodiment, in the idle refresh operation, the stabilization time threshold value is set to be large compared to the forced refresh operation. That is, in the idle refresh operation, a stabilization condition is set to be stringent compared to that of the forced refresh operation. The stabilization condition is satisfied when a length of a continuous period during which a positioning error amount of the magnetic head 22 is maintained to be less than or equal to a stabilization amplitude threshold value Thₛₜ reaches a stabilization time threshold value.

Therefore, in the case of the idle refresh operation, it is possible to improve write quality compared to the case of the forced refresh operation. In the case of the forced refresh operation, it is possible to reduce the time required for a series of operations including the refresh operation compared to the case of the idle refresh operation.

According to the embodiment, the controller 30 acquires the results of the refresh operation for each of the forced refresh operation and the idle refresh operation (see, for example, S501 to S504 in FIG. 15). The controller 30 adjusts the stability condition according to the result of the refresh operation (see, for example, S505 to S509 in FIG. 15, and FIG. 16).

Therefore, it is possible to improve the write quality for each of the forced refresh operation and the idle refresh operation. As a result, it is possible to reduce the execution frequency of the refresh operations.

Furthermore, according to the embodiment, the controller 30 reduces the value of the ATI counter of the target track to a value α corresponding to a write off-track amount in response to the refresh operation. Then, the controller 30 adjusts the stabilization time threshold value using at least an ATI counter update ratio R_{upd}, which is numerical information corresponding to the value α.

More specifically, the controller 30 calculates the refresh effect EFT based on the ATI counter update ratio R_{upd} and an ATI counter increment ratio R_{inc}, which is numerical information corresponding to an increment amount of the ATI counter of the track 50 in the vicinity of the target track. The controller 30 calculates the adjusted processing time by applying a weight to the stability condition establishment time Tₛₜ of the processing time Tₒₚ. The controller 30 calculates an adjusted refresh efficiency EFY2 by dividing a refresh effect EFT by the adjusted processing time. The controller 30 adjusts the stabilization time threshold value so that the adjusted refresh efficiency EFY2 is increased.

Therefore, it is possible to improve the write quality for each of the forced refresh operation and the idle refresh operation. As a result, it becomes possible to reduce the execution frequency of the refresh operation.

According to the embodiment, the weight applied to the stability condition establishment time Tₛₜ in the case of the idle refresh operation is smaller than the weight applied to the stability condition establishment time Tₛₜ in the case of the forced refresh operation.

Therefore, in the case of the idle refresh operation, it is possible to improve the write quality compared to the case of the forced refresh operation. In the case of the forced refresh operation, it is possible to reduce the time required for a series of operations including the refresh operation compared to the case of the idle refresh operation.

According to the embodiment, the controller 30 variably updates the value of the ATI counter of the target track even in a write operation. More specifically, the controller 30 calculates the value α corresponding to the write off-track amount during the write operation (see, for example, S103 in FIG. 11). When the value of the ATI counter of the target track is smaller than the value α, the controller 30 updates the value of the ATI counter of the target track with the value α (see, for example, the case of the positive determination in S107 of FIG. 11). When the value of the ATI counter of the target track is larger than the value α and a range into which data is written by the write operation is a part of the target track, the controller 30 maintains the value of the ATI counter of the target track (see, for example, the case of the negative determination in S107 in FIG. 11). When the range into which data is written by the write operation is the entire target track, the controller 30 updates the value of the ATI counter of the target track with the value α (see, for example, the case of the positive determination in S104 in FIG. 11).

In this way, by variably updating the value of the ATI counter of the target track according to actual write quality (in this case, the write off-track amount) even during the write operation, it is possible to reduce a discrepancy between the value of the ATI counter and the actual influence of the ATI received by the track 50.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A magnetic disk device comprising:
a magnetic disk that includes a plurality of storage areas arranged in a radial direction;
a magnetic head;
a memory in which a plurality of counters, each of which corresponds to one of the plurality of storage areas, are stored; and
a controller configured to:
execute a write operation in response to a write command;
when executing the write operation, increase a value of a counter corresponding to a storage area in the vicinity of a target storage area to which data is written in the write operation;
execute a refresh operation in response to each of a first trigger and a second trigger different from the first trigger, the refresh operation including a seek operation to move the magnetic head to a first storage area among the plurality of storage areas, a stabilization operation to wait for attenuation of residual vibration of the magnetic head after the seek operation is completed, and a rewrite operation to rewrite all data of the first storage area to the first storage area after the stabilization operation is completed;
decrease a value of a counter corresponding to the first storage area in response to the rewrite operation; and
increase a value of a counter corresponding to a second storage area in response to the rewrite operation, the second storage area being a storage area in the vicinity of the first storage area among the plurality of storage areas, wherein
the stabilization operation includes an operation to determine whether a completion condition is satisfied, and
the completion condition is a first condition when the refresh operation is executed in response to the first trigger and a second condition different from the first condition when the refresh operation is executed in response to the second trigger.

2. The magnetic disk device according to claim 1, wherein
the first trigger is the value of the counter corresponding to the first storage area reaching a first threshold value, and
the second trigger is the magnetic disk device being in an idle state.

3. The magnetic disk device according to claim 2, wherein the second condition is stricter in timing requirements than the first condition.

4. The magnetic disk device according to claim 1, wherein the completion condition is a length of a continuous period during which a magnitude of a positioning error amount of the magnetic head is maintained to be less than or equal to a second threshold value reaching a third threshold value, and
the third threshold values in the first and second conditions are different.

5. The magnetic disk device according to claim 1, wherein the controller is configured to acquire a result of the rewrite operation for each of a first refresh operation which is the refresh operation executed in response to the first trigger, and a second refresh operation which is the refresh operation executed in response to the second trigger, and adjust the completion condition based on the result.

6. The magnetic disk device according to claim 5, wherein the controller is configured to:
reduce, in response to the rewrite operation, a value of a first counter, which is the counter corresponding to the first storage area, to a first value corresponding to a positioning error amount of the magnetic head during the rewrite operation; and
adjust the completion condition using at least the first value.

7. The magnetic disk device according to claim 6, wherein the controller is configured to:
calculate a second value corresponding to the result of the rewrite operation based on the first value and an increment amount for the value of the counter corresponding to the second storage area;
calculate a third value that is a sum of: (1) a time during which a weight required for the stabilization operation was applied and (2) a time from when the stabilization operation was completed to when the rewrite operation was completed, the weight applied during the rewrite operation of the first refresh operation being different from the weight applied during the rewrite operation of the second refresh operation;
calculate a fourth value representing an efficiency of the rewrite operation by dividing the second value by the third value; and
adjust the completion condition so that the fourth value becomes larger.

8. The magnetic disk device according to claim 7, wherein
the first trigger is the value of the counter corresponding to the first storage area reaching a first threshold value,
the second trigger is the magnetic disk device being in an idle state, and
the weight applied during the rewrite operation of the second refresh operation is smaller than the weight applied during the rewrite operation of the first refresh operation.

9. The magnetic disk device according to claim 1, wherein the controller is configured to variably update, in response to the write operation, a value of a second counter, which is a counter corresponding to the target storage area, according to the positioning error amount of the magnetic head during the write operation.

10. The magnetic disk device according to claim 9, wherein the controller is configured to:
calculate a fifth value corresponding to the positioning error amount of the magnetic head during the write operation,
update the value of the second counter with the fifth value when the value of the second counter is smaller than the fifth value,
maintain the value of the second counter when the value of the second counter is larger than the fifth value and a range into which the data is written by the write operation is a part of a storage area adjacent to the target storage area, and
update the value of the second counter with the fifth value when the range into which the data is written by the write operation is the entire target storage area.

11. The magnetic disk device according to claim 10, wherein the first storage area and the second storage area are adjacent to each other.

12. A magnetic disk device comprising:
a magnetic disk that includes a plurality of storage areas arranged in a radial direction;
a magnetic head;
a memory in which a plurality of counters, each of which corresponds to one of the plurality of storage areas, are stored; and
a controller configured to execute a write operation in response to a write command, to write data to a first storage area which is one storage area among the plurality of storage areas, variably update, in response to the write operation, a value of a first counter, which is a counter corresponding to the first storage area among the plurality of counters, according to a positioning error amount of the magnetic head during the write operation, and increase a value of a counter among the plurality of counters corresponding to a second storage area, which is a storage area in the vicinity of the first storage area among the plurality of storage areas.

13. The magnetic disk device according to claim 12, wherein the controller is configured to:
calculate a first value corresponding to the positioning error amount of the magnetic head during the write operation;
update the value of the first counter with the first value when the value of the first counter is smaller than the first value;
maintain the value of the first counter when the value of the first counter is larger than the first value and a range into which the data is written by the write operation is a part of the second storage area; and
update the value of the first counter with the first value when the range into which the data is written by the write operation is the entire first storage area.

14. The magnetic disk device according to claim 13, wherein the first storage area and the second storage area are adjacent to each other.

15. A method of performing a refresh operation in a magnetic disk device comprising a magnetic disk that includes a plurality of storage areas arranged in a radial direction and a magnetic head, said method comprising:
executing a first refresh operation in response to a first trigger and executing a second refresh operation in response to a second trigger that is different from the first trigger, wherein each of the first and second refresh operations includes a seek operation to move the magnetic head to a first storage area among the plurality of storage areas, a stabilization operation to wait for attenuation of residual vibration of the magnetic head after the seek operation is completed, and a rewrite operation to rewrite all data of the first storage area to the first storage area after the stabilization operation is completed;
decreasing a value of a counter corresponding to the first storage area in response to the rewrite operation; and
increasing a value of a counter corresponding to a second storage area in response to the rewrite operation, the second storage area being a storage area in the vicinity of the first storage area among the plurality of storage areas, wherein
the stabilization operation includes an operation to determine whether a completion condition is satisfied, and
the completion condition is a first condition when the first refresh operation is executed and a second condition different from the first condition when the second refresh operation is executed.

16. The method according to claim 15, wherein
the first trigger is the value of the counter corresponding to the first storage area reaching a first threshold value,
the second trigger is the magnetic disk device being in an idle state.

17. The method according to claim 16, wherein
the completion condition is a length of a continuous period during which a magnitude of a positioning error amount of the magnetic head is maintained to be less than or equal to a second threshold value reaching a third threshold value, and
the third threshold values in the first and second conditions are different.

18. The method according to claim 15, further comprising:
acquiring a result of the rewrite operation for each of the first refresh operation and the second refresh operation; and
adjusting the completion condition based on the result.

19. The method according to claim 18, further comprising:
reducing, in response to the rewrite operation, a value of a first counter, which is the counter corresponding to the first storage area, to a first value corresponding to a positioning error amount of the magnetic head during the rewrite operation; and
adjusting the completion condition using at least the first value.

20. The method according to claim 19, further comprising:
calculating a second value corresponding to the result of the rewrite operation based on the first value and an increment amount for the value of the counter corresponding to the second storage area;
calculating a third value that is a sum of: (1) a time during which a weight required for the stabilization operation was applied and (2) a time from when the stabilization operation was completed to when the rewrite operation was completed, the weight applied during the rewrite operation of the first refresh operation being different from the weight applied during the rewrite operation of the second refresh operation;
calculating a fourth value representing an efficiency of the rewrite operation by dividing the second value by the third value; and
adjusting the completion condition so that the fourth value becomes larger.
